(19) United States
(12) Patent Application Publication
(10) Pub. No.: US 2005/0098988 A1
(43) Pub. Date: May 12, 2005

(54) Pressure-enhanced, adaptive inflator device

(76) Inventor: Bradley W. Smith, Ogden, UT (US)

Correspondence Address: AUTOLIV ASP, INC;Attn: Sally J. Brown ESQ, 3350 Airport Rd, OGDEN, UT, 84405, US

(21) Appl. No.: 10/706,130

(22) Filed: Nov. 12, 2003

(51) Int. Cl. B60R 21/26

(52) U.S. Cl. 280/735; 280/736; 102/531

(57) ABSTRACT

An inflator device that includes a diffuser chamber with a first combustion chamber and a second combustion chamber each connected to the diffuser chamber. A supply of a first gas-generating pyrotechnic material having a burn rate that is pressure dependent is contained within the first combustion chamber. The first combustion chamber forms or includes an orifice providing independent fluidic communication between the first combustion chamber and the diffuser chamber. This orifice throttles a single stage combustion wherein the supply of the first gas-generating pyrotechnic material is selectively reactable to produce a first combustion chamber single stage combustion product gas. A supply of a second gas-generating pyrotechnic material is contained within the second combustion chamber. The second combustion chamber forms or includes an orifice that provides independent fluidic communication between the second combustion chamber and the diffuser chamber. This orifice throttles a single stage combustion wherein the supply of the second gas-generating pyrotechnic material is selectively reactable to produce a second combustion chamber single stage combustion product gas. The diffuser chamber forms or includes at least one exit orifice. This diffuser exit orifice throttles a dual stage combustion wherein the supply of the first gas-generating pyrotechnic material is reactable to produce a first combustion chamber dual stage combustion product gas and the supply of the second gas-generating pyrotechnic material is reactable to produce a second combustion chamber dual stage combustion product gas.

### BACKGROUND OF THE INVENTION

This invention relates generally to inflator devices such as for use in inflating inflatable restraint airbag cushions to provide impact protection to occupants of motor vehicles. More particularly, the invention relates to inflators which rely primarily on reaction of a combustible material for the production of an inflation gas and such as may provide an inflation gas output which is adaptive to factors such as one or more crash and occupant conditions.

It is well known to protect a vehicle occupant using a cushion or bag, e.g., an “airbag,” that is inflated or expanded with gas when the vehicle encounters sudden deceleration, such as in a collision. In such systems, the airbag cushion is normally housed in an uninflated and folded condition to minimize space requirements. Upon actuation of the system, the cushion begins being inflated in a matter of no more than a few milliseconds with gas produced or supplied by a device commonly referred to as an “inflator.”

Various types of inflator devices have been disclosed in the art for the inflation of an airbag such as used in inflatable restraint systems. One type of known inflator device derives inflation gas from a combustible pyrotechnic gas generating material which, upon ignition, generates a quantity of gas sufficient to inflate the airbag.

In general, the burn rate for a gas generant composition can be represented by the equation (1), below:
r_{b}=k(P)ⁿ (1)
where,
r_{b}=burn rate (linear)
k=constant
P=pressure
n=pressure exponent, where the pressure exponent is the slope of a linear regression line drawn through a log-log plot of burn rate versus pressure.
   As will be appreciated, the pressure exponent in the above equation generally corresponds to the performance sensitivity of a respective gas generant material, with lower burn rate pressure exponents corresponding to gas generant materials which desirably exhibit corresponding lesser or reduced pressure sensitivity.

Typical pyrotechnic-based inflator devices commonly include or incorporate certain component parts including, for example, a pressure vessel wherein the pyrotechnic gas generating material is burned, various filter or inflation medium treatment devices to properly condition the inflation medium prior to passage into the associated airbag cushion, and a diffuser to assist in the proper directing of the inflation medium into the associated airbag cushion.

Sodium azide was a previously commonly accepted and used gas generating material. The use of sodium azide and certain other azide-based gas generant materials may, however, involve or raise potential concerns such as involving handling, supply and disposal of such materials. Further, economic and design considerations have also resulted in a need and desire for alternatives to azide-based pyrotechnics and related gas generants. For example, an interest in minimizing or at least reducing overall space requirements for inflatable restraint systems and particularly such requirements related to the inflator component of such systems has stimulated a quest for gas generant materials that provide relatively higher gas yields per unit volume as compared to typical or usual azide-based gas generants. Still further, automotive and airbag industry competition has generally lead to a desire for gas generant compositions that satisfy one or more conditions such as being composed of or utilizing less costly ingredients or materials and being amenable to processing via more efficient or less costly gas generant processing techniques.

As a result, the development and use of other suitable gas generant materials has been pursued. Through such efforts, various azide-free pyrotechnics have been developed for use in such inflator device applications including at least some that have or exhibit a relatively high burn rate pressure dependency.

In view of possibly varying operating conditions and, in turn, possibly varying desired performance characteristics, there is a need and a desire to provide what has been termed an “adaptive” inflator device and a corresponding inflatable restraint system. With an adaptive inflator device, output parameters such as one or more of the quantity, supply, and rate of supply (e.g., mass flow rate) of inflation gas, for example, can be selectively and appropriately varied dependent on selected operating conditions such as ambient temperature, occupant presence, seat belt usage and rate of deceleration of the motor vehicle, for example.

While such adaptive systems are desirable, they typically require the inclusion of additional components as a part of the associated inflator device and such as may undesirably increase one or more of the size, cost and weight of the inflator device. For example, various proposed or currently available dual stage inflator devices appear based on the principle of packaging together two separate inflators. As a result, such inflator combinations commonly include two distinct pressure vessels, two sets of filter or inflation gas treatment components, one for the output of each of the pressure vessels, and two distinct diffusers, again one for the output of each of the pressure vessels. Thus, it has been difficult to provide an adaptive inflator which will satisfactorily meet the size, cost and weight limitations associated with modern vehicle design.

Perhaps the simplest form of an adaptive inflation system is an inflation system which utilizes an inflator which provides two levels or stages of performance, e.g., commonly called or referred to as a “two-stage” or “dual stage” inflator. Those skilled in the art, however, will appreciate that even a relatively simple two-stage inflator may require actuation and/or control systems of significantly increased sophistication, as compared to typical single stage inflators, in order to realize particularly desired adaptive performance capabilities.

Commonly assigned Smith, U.S. Pat. No. 6,314,889, issued 13 Nov. 2001, the disclosure of which patent is hereby incorporated by reference herein and made a part hereof, has been developed, at least in part, in response to such needs and demands as described above. This patent discloses an adaptive output pyrotechnic inflator device and control assembly combination wherein the inflator device includes a first chamber wherein a supply of a combustible gas generant material having a burn rate which is pressure dependent is burned to produce gas. The inflator device also includes an exit of adjustable cross sectional area in fluid communication with the first chamber and wherethrough at least a portion of the product gas can exit the inflator device. The control assembly is in operational control communication with the inflator device and provides a control signal to the inflator device to effect adjustment of the cross sectional area of the exit dependent on at least one chosen product gas output performance factor.

While such an inflator device and control assembly combination have, at least in part, been successful in overcoming some of the shortcomings of prior assemblies, further improvements and developments are desired and have been sought. For example, in various prior art dual stage inflators wherein, in response to a high speed crash incident, combustion of both a first and a second stage is initiated, the first stage combustion, when coupled with the second stage combustion, may continue to produce product gas beyond the desired time period. As a result, product gas may still be produced during the time the occupant is fully engaged with the associated passive restraint cushion. As will be appreciated, it has been generally believed desirable that a passive restraint cushion be venting rather than being further expanded or filled at the point in time when engaged by the occupant.

Moreover, while passive restraint cushions may incorporate vents such as to permit the controlled deflation or venting of the cushion after inflation, the simple enlargement of such vents may not be practical or feasible for an installation to achieve or provide desired adaptive performance. For example, such an increase in cushion ventilation may undesirably decrease the effectiveness of the cushion and inflator device during a single stage combustion where only the single stage combustion is actuated, such as may be desired in response to a low speed crash incident.

Thus, there is a continuing need and demand for alternative adaptive inflator devices and associated combinations such as may effectively overcome or minimize some or all of the above-identified shortcoming or limitations. In particular, there is a need and a demand for such an adaptive performance inflator device which more freely permits the use of azide-free pyrotechnics, such as those that have or exhibit a relatively high burn rate pressure dependency. Further, there is a need and a demand for adaptive performance inflatable restraint assembly combinations that are conducive for use in conjunction with relatively simple control arrangements.

### SUMMARY OF THE INVENTION

A general object of the invention is to provide an improved inflator device and related combinations.

Another general object of the invention is to provide an improved adaptive inflator device wherein during a single stage combustion a controlling orifice formed in a combustion chamber throttles a gas-generating pyrotechnic material reaction to produce a single stage combustion product gas, and during a dual stage combustion a plurality of diffuser orifices formed in a diffuser chamber throttles the gas-generating pyrotechnic material reaction to produce a dual stage combustion product gas.

A more specific objective of the invention is to overcome one or more of the problems described above.

The general objects of the invention can be attained, at least in part, through an inflator device which includes a diffuser chamber and a first combustion chamber connected to the diffuser chamber. A supply of a first gas-generating pyrotechnic material having a burn rate that is pressure dependent is contained within the first combustion chamber and, wherein at least a portion of the supply of the first gas-generating pyrotechnic material is reactable. The gas-generating pyrotechnic material has a burn rate pressure dependency of at least about 0.55, where the burn rate pressure dependency is represented by n in a burn rate expression:
r_{b}=k(P)ⁿ
where r_{b} is the burn rate of the first gas-generating pyrotechnic material, k is a constant, P is pressure, and n is a slope of a linear regression line drawn through a log-log plot of burn rate versus pressure. The first combustion chamber forms a controlling orifice. This controlling orifice provides independent fluidic communication between the first combustion chamber and the diffuser chamber. This controlling orifice serves to throttle a single stage combustion wherein the supply of the first gas-generating pyrotechnic material is selectively reactable to produce a first combustion chamber single stage combustion product gas.

The inflator device also includes a second combustion chamber connected to the diffuser chamber. A supply of a second gas-generating pyrotechnic material is contained within the second combustion chamber and, wherein at least a portion of the supply of the second gas-generating pyrotechnic material is reactable. A controlling orifice formed by the second combustion chamber provides independent fluidic communication between the second combustion chamber and the diffuser chamber. This controlling orifice throttles a single stage combustion wherein the supply of the second gas-generating pyrotechnic material is selectively reactable to produce a second combustion chamber single stage combustion product gas.

A plurality of diffuser orifices are formed in the diffuser chamber. The diffuser orifices throttle a dual stage combustion wherein the supply of the first gas-generating pyrotechnic material is reactable to produce a first combustion chamber dual stage combustion product gas and the supply of the second gas-generating pyrotechnic material is reactable to produce a second combustion chamber dual stage combustion product gas.

In accordance with a preferred embodiment of the invention, with operation of only one of the first or the second combustion chambers, the inflation fluid flow is too low or insufficient for the orifice area of the diffuser to serve as a controlling orifice or otherwise choke the inflation gas flow therethrough. However, with both the first and the second combustion chambers operating, the combined inflation fluid flow is sufficiently great as to overwhelm the diffuser exit area (e.g., the diffuser orifices). As a result, the flow choke point or throttling orifice area is effectively moved or relocated from the exit areas or orifices of each of the combustion chambers, respectively, to the diffuser exit area (e.g., the diffuser orifices) and such that the net operating pressure within the inflator device is controllably increased. As will be appreciated by those skilled in the art and guided by the teachings herein provided, varying effects are attainable by employing a gas generant having a high burn rate pressure dependency in either or both chambers of an inflator device in accordance with the invention. For example, in accordance with certain preferred embodiments of the invention and when using a gas generant having a high burn rate pressure dependency, the benefits resulting from such operation may desirably include a longer burn time or duration for a single chamber combustion operation and a shorter burn time or duration for a dual chamber combustion operation.

The prior art generally fails to provide an adaptive inflator device and associated combinations having as simple and as effective a design and operation as may be desired. In particular, the prior art generally fails to provide such adaptive inflator devices and associated combinations such as may provide or result in a long burning and low mass flow combustion such as may be desired in response to a low speed crash incident or in event of an out-of-position occupant, and a relatively short burning and increased or high mass flow combustion such as may be desired in response to a high speed crash incident, for example.

The invention further comprehends an inflator device including a diffuser chamber, with a first combustion chamber connected to the diffuser chamber. A supply of a first gas-generating pyrotechnic material having a burn rate that is pressure dependent is contained within the first combustion chamber and wherein at least a portion of the supply of the first gas-generating pyrotechnic material is reactable. The gas-generating pyrotechnic material has a burn rate pressure dependency of at least about 0.55, where the burn rate pressure dependency is represented by n in a burn rate expression:
r_{b}=k(P)ⁿ
where r_{b} is the burn rate of the first gas-generating pyrotechnic material, k is a constant, P is pressure, and n is a slope of a linear regression line drawn through a log-log plot of burn rate versus pressure. A first initiator is in discharge communication with the first combustion chamber and in operational initiation communication with the supply of the first gas-generating pyrotechnic material. The first initiator selectively initiates reaction of the supply of the first gas-generating pyrotechnic material in one of a single stage combustion and a dual stage combustion. The first combustion chamber forms at least one controlling orifice which provides independent fluidic communication between the first combustion chamber and the diffuser chamber. The at least one first combustion chamber controlling orifice throttles the reaction of the supply of the first gas-generating pyrotechnic material during the single stage combustion to produce a first combustion chamber single stage product gas.

The inflator device further includes a second combustion chamber connected to the diffuser chamber. A supply of a second gas-generating pyrotechnic material is contained within the second combustion chamber and wherein at least a portion of the supply of the second gas-generating pyrotechnic material is reactable. A second initiator is in discharge communication with the second combustion chamber and in operational initiation communication with the supply of the second gas-generating pyrotechnic material, to selectively initiate reaction of the supply of second gas-generating pyrotechnic material in one of the single stage combustion and the dual stage combustion. The second combustion chamber forms at least one controlling orifice which provides independent fluidic communication between the second combustion chamber and the diffuser chamber, and throttles the reaction of the supply of second gas-generating pyrotechnic material during the single stage combustion to produce the second combustion chamber single stage product gas.

The diffuser chamber forms a plurality of diffuser orifices which throttle the reaction of the supply of the first gas-generating pyrotechnic material and the reaction of the supply of the second gas-generating pyrotechnic material during the dual stage combustion, wherein the supply of the first gas-generating pyrotechnic material is reactable to produce a first combustion chamber dual stage combustion product gas and the supply of the second gas-generating pyrotechnic material is reactable to produce a second combustion chamber dual stage combustion product gas.

The invention still further comprehends a combination including an inflator device including a diffuser chamber forming a plurality of diffuser orifices. The inflator device includes a first combustion chamber connected to the diffuser chamber and containing a supply of a first gas-generating pyrotechnic material having a burn rate that is pressure dependent. The first gas-generating pyrotechnic material has a burn rate pressure dependency of at least about 0.55. A first initiator is in discharge communication with the first combustion chamber, and in operational initiating contact with the supply of the first gas-generating pyrotechnic material. At least one controlling orifice is formed by the first combustion chamber and provides independent fluidic communication between the first combustion chamber and the diffuser chamber. A second combustion chamber is connected to the diffuser chamber and contains a supply of a second gas-generating pyrotechnic material. A second initiator is in discharge communication with the second combustion chamber and in operational initiating contact with the supply of the second gas-generating pyrotechnic material. At least one controlling orifice is formed by the second combustion chamber and provides independent fluidic communication between the second combustion chamber and the diffuser chamber.

The combination further includes a control assembly in operational control communication with the inflator device. The control assembly provides a reaction initiating signal to one of the first initiator to initiate reaction of at least a portion of the supply of the first gas-generating pyrotechnic material contained within the first combustion chamber and the second initiator to initiate reaction of at least a portion of the supply of the second gas-generating pyrotechnic material contained within the second combustion chamber during a single stage combustion, or a reaction initiating signal to the first initiator to initiate reaction of the supply of the first gas-generating pyrotechnic material and the second initiator to initiate reaction of the supply of the second gas-generating pyrotechnic material during a dual stage combustion.

As used herein, references to the “combustion pressure” of a chamber or the like are to be understood to generally refer to the maximum pressure attained within the chamber upon the combustion of the reactive contents thereof, independent of any spikes in pressure such as due to or caused by initiator(s) or the ignition system itself associated with the chamber and the initiation of reaction of the contents thereof.

Other objects and advantages will be apparent to those skilled in the art from the following detailed description taken in conjunction with the appended claims and drawings.

### BRIEF DESCRIPTION OF THE DRAWINGS

FIG. 1 is a partially in section, schematic drawing of an inflator device and control assembly combination in accordance with one preferred embodiment of the invention.

FIG. 2 is a graphical depiction of inflating flow rates of the inflator device shown in FIG. 1 in accordance with one preferred embodiment of the invention and as described in Example 1.

FIG. 3 is a graphical depiction of integrated inflating flow of the inflator device shown in FIG. 1 in accordance with one preferred embodiment of the invention and as described in Example 1.

### DETAILED DESCRIPTION OF THE INVENTION

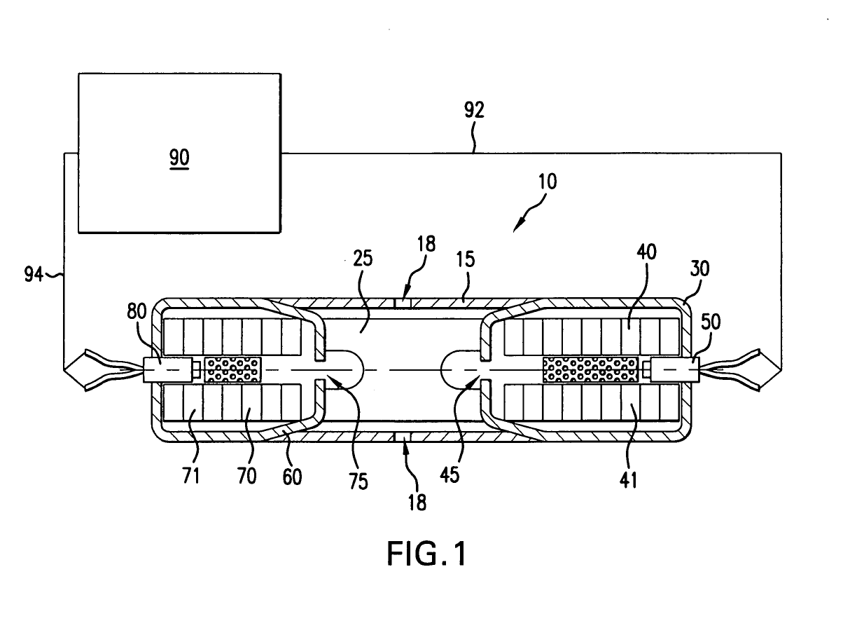

The present invention may be embodied in a variety of structures. As representative, FIG. 1 illustrates the present invention as embodied in an inflator device 10 including a diffuser chamber 15 forming at least one diffuser orifice 18. As shown in FIG. 1, the diffuser chamber 15 preferably forms a plurality of diffuser orifices 18 wherethrough inflation fluid, e.g., inflation gas generated, produced or otherwise formed by the inflator device 10 can be properly discharged into communication with an associated inflatable device (not shown). Preferably, a suitable gas treatment element 25, such as in the form of a cooling medium, may be positioned or disposed within the diffuser chamber 15 and positioned such that at least a portion of the inflation gas exiting the inflator device 10 through the diffuser orifices 18 moves or flows through the gas treatment element 25, as shown for example in FIG. 1. The gas treatment element can be included to serve as a heat sink effective to reduce the temperature of the inflation fluid passing therethrough, prior to discharge of such inflation fluid from the inflator device. Alternatively or additionally, the gas treatment element can also serve to filter or otherwise remove particulates from the inflation fluid passing therethrough.

While the invention has been described above making specific reference to an inflator device which includes a gas treatment element, those skilled in the art and guided by the teachings herein provided will appreciate that the broader practice of the invention is not necessarily so limited. For example, if desired, the invention can be practiced with an inflator device that does not include such a gas treatment element.

The inflator device 10 also includes a first combustion chamber 30 connected to the diffuser chamber 15. The first combustion chamber 30 can be connected to the diffuser chamber 15 using any suitable mechanical connecting or fastening means such as known to those having ordinary skill in the art and guided by the teaching herein provided. For example, the first combustion chamber 30 may be welded to the diffuser chamber 15.

As shown in FIG. 1, a supply of a first gas-generating pyrotechnic material 40 is disposed or contained within the first combustion chamber 30. At least a portion of the supply of the first gas-generating pyrotechnic material 40 is therewithin reactable, e.g., combustible, to generate or produce a product gas. Preferably, the supply of the first gas-generating pyrotechnic material 40 has a burn rate that is pressure dependent as herein described. The first combustion chamber 30 is shown as containing or including a selected supply of the first gas-generating pyrotechnic material 40 such as in the form of a plurality of wafers or discs 41. While the invention may, if desired, be practiced employing various gas generant materials, such as are known in the art, the invention has particular perceived utility when used in conjunction with those gas generant materials, e.g., pyrotechnics, which have or exhibit a relatively high burn rate pressure dependency, e.g., have a burn rate pressure exponent of 0.55 or greater, and, in accordance with certain preferred embodiments, have a burn rate pressure exponent of at least about 0.65 and, in accordance with certain preferred embodiments, have a burn rate pressure exponent more preferably within a range of about 0.65 to about 0.70. In certain preferred embodiments of the invention, it is generally desirable to avoid the utilization of a gas generating pyrotechnic material having a burn rate pressure exponent greater than about 0.70. In particular, gas generating pyrotechnic materials having a burn rate pressure exponent greater than about 0.70 may exhibit so great a sensitivity to pressure that inflator performance of sufficient reliability may not be practically attainable. Such highly pressure sensitive gas-generating pyrotechnic material can be represented by a linear regression line having a large slope drawn through a log-log plot of burn rate versus pressure.

Suitable gas generant materials include various newly developed azide-free pyrotechnics. The metal ammine nitrate-containing azide-free gas generant compositions disclosed Taylor et al., U.S. Pat. No. 6,103,030, issued 15 Aug. 2000, the disclosure of which is fully incorporated by reference herein and made a part hereof, are an example of one preferred form of an azide-free gas generant composition having a suitable high burn rate pressure dependency for use in the practice of the invention. As disclosed in that patent, one particularly preferred gas generant composition in accordance therewith includes: between about 35 and about 50 wt % of guanidine nitrate fuel, between about 30 and about 55 wt % copper diammine dinitrate oxidizer, between about 2 and about 10 wt % silicon dioxide burn rate enhancing and slag formation additive, and between about 0 and about 25 wt % ammonium nitrate supplemental oxidizer. As the burn rate of such pyrotechnic gas generant materials is a strong function of pressure, higher combustion pressures can produce or result in higher mass flow rates of produced or formed gases. Correspondingly, with such pyrotechnic gas generant materials, lower combustion pressures can produce or result in lower mass flow rates of produced or formed gases.

The first combustion chamber 30 forms at least one orifice 45 to provide fluidic communication between the first combustion chamber 30, wherein the supply of the first gas-generating pyrotechnic material 40 is contained, and the diffuser chamber 15 so that the product gas produced by combustion of at least a portion of the first gas-generating pyrotechnic material 40 is allowed to exit the first combustion chamber 30 through the orifice 45 and into the diffuser chamber 15. In one preferred embodiment of this invention, the product gas passes through the gas treatment element 25 and exits the diffuser chamber 15 through the diffuser orifices 18.

The orifice 45 serves to throttle a single stage combustion wherein the supply of the first gas-generating pyrotechnic material 40 is selectively reacted to produce a first combustion chamber single stage combustion product gas. That is, in the event of such a single stage combustion, the orifice 45 is a controlling orifice. During such single stage combustion, a relatively low combustion pressure is developed within the first combustion chamber 30. Preferably, the orifice 45 controls the internal combustion pressure developed within the first combustion chamber 30 so that the internal combustion pressure is not greater than about 2000 psi, preferably in the range of about 1200 psi to about 1500 psi. Further, the first gas-generating pyrotechnic material 40 has a burn time or duration of at least about 60 msec and, preferably, a burn time or duration of about 80 msec during such a single stage combustion.

The inflator device 10 also includes a first initiator 50 in discharge communication with the first combustion chamber 30, and in operational initiating contact with the supply of the first gas-generating pyrotechnic material 40. As shown in FIG. 1, the first initiator 50 is preferably positioned at least partially within the first combustion chamber 30 to contact at least a portion of the supply of the first gas-generating pyrotechnic material 40.

In accordance with one preferred embodiment of the invention, during operation of the inflator device 10, the first initiator 50 may receive a signal from a control assembly 90 in operational control communication with the inflator device 10. As shown in FIG. 1, a lead wire 92 operatively connects the control assembly 90 to the first initiator 50 and transmits a signal from the control assembly 90 to the first initiator 50 to activate the first initiator 50, for example. In response to such a signal, the first initiator 50 is activated to selectively initiate the reaction of the supply of first gas-generating pyrotechnic material 40 to produce one of a first combustion chamber single stage combustion product gas and a first combustion chamber dual stage combustion product gas.

As shown in FIG. 1, the inflator device 10 also includes a second combustion chamber 60 connected to the diffuser chamber 15. The second combustion chamber 60 can be connected to the diffuser chamber 15 using any suitable mechanical connecting or fastening means such as known to those having ordinary skill in the art and guided by the teachings herein provided. For example, the second combustion chamber 60 may be welded to the diffuser chamber 15. A supply of a second gas-generating pyrotechnic material 70 is contained within the second combustion chamber 60. The second combustion chamber 60 is shown as containing or including a selected supply of the second gas-generating pyrotechnic material 70 such as in the form of a plurality of wafers or discs 71. It will be apparent to those having ordinary skill in the art and guided by the teachings herein provided that the invention may, if desired, be practiced employing various gas generant materials, such as are known in the art. At least a portion of the supply of the second gas-generating pyrotechnic material 70 is reactable to produce a product gas. Preferably, the second gas-generating pyrotechnic material 70 is different from the first gas-generating pyrotechnic material 40. For example, the second gas-generating pyrotechnic material 70 may have a different burn rate pressure exponent, preferably having a burn rate pressure exponent less than the burn rate pressure exponent of the first gas-generating pyrotechnic material 40.

In one preferred embodiment of the invention, the supply of second gas-generating pyrotechnic material 70 comprises a pyrotechnic material having a high burn rate and a relatively short burn time or duration. Preferably, the second gas-generating pyrotechnic material 70 has a burn time or duration of less than about 50 msec and, preferably, a burn time or duration in the range of about 35 to 40 msec. Additionally, while the invention may, if desired, be practiced employing various gas generant materials, as are known in the art, the invention has particular perceived utility when used in conjunction with those gas generant materials, e.g., pyrotechnics, which have or exhibit a relatively low burn rate pressure dependency, e.g., have a burn rate pressure exponent of less than about 0.55 and, in accordance with certain preferred embodiments, have a burn rate pressure exponent of less than about 0.45 and, in accordance with certain preferred embodiments, have a burn rate pressure exponent more preferably within a range of about 0.30 to about 0.40. In accordance with certain preferred embodiments of the invention it is desirable that the second gas-generating pyrotechnic material have a relatively low pressure exponent such that combustion performance of the second gas-generating pyrotechnic material 70 does not change substantially during the single stage combustion and the dual stage combustion.

In an alternative preferred embodiment of the invention, the supply of second gas-generating pyrotechnic material may comprise a gas-generating pyrotechnic material that has or exhibits a relatively high burn rate pressure dependency, e.g., has a burn rate pressure exponent of 0.55 or greater, and in accordance with certain preferred embodiments, has a burn rate pressure exponent of at least about 0.65 and, in accordance with certain preferred embodiments, have a burn rate pressure exponent more preferably within a range of about 0.65 to about 0.70. In certain preferred embodiments of this invention, the second gas-generating pyrotechnic material 70 may be the same or similar to the first gas-generating pyrotechnic material 40. Alternatively, the second gas-generating pyrotechnic material 70 may comprise a pyrotechnic material different from the first gas-generating pyrotechnic material 40 but which gas-generating pyrotechnic material also has or exhibits a relatively high burn rate pressure exponent, such as described above.

The second combustion chamber 60 forms or includes at least one orifice 75 providing independent fluidic communication between the second combustion chamber 60 and the diffuser chamber 15. The product gas produced as a result of the combustion of at least a portion of the second gas-generating pyrotechnic material 70 exits from within the second stage combustion chamber 60 through the orifice 75 and into the diffuser chamber 15. In one preferred embodiment of this invention, the product gas passes through the gas treatment element 25 and exits the inflator device 10 through the diffuser orifices 18.

The inflator device 10 also includes a second initiator 80 in discharge communication with the second combustion chamber 60, and in operational initiating contact with the supply of the second gas-generating pyrotechnic material 70. As shown in FIG. 1, the second initiator 80 is preferably positioned at least partially within the second combustion chamber 60 to contact at least a portion of the supply of the second gas-generating pyrotechnic material 70.

In accordance with one preferred embodiment of the invention, during operation of the inflator device 10, the second initiator 80 may receive a signal from the control assembly 90 in operational control communication with the inflator device 10. As shown in FIG. 1, a lead wire 94 operatively connects the control assembly 90 to the second initiator 80 and transmits the signal from the control assembly 90 to the second initiator 80 to activate the second initiator 80, for example. In response to the signal, the second initiator 80 is activated to selectively initiate the reaction of the supply of second gas-generating pyrotechnic material 70 to produce one of a second combustion chamber single stage combustion product gas and a second combustion chamber dual stage combustion product gas.

The orifice 75 serves to throttle a single stage combustion, wherein the supply of the second gas-generating pyrotechnic material 70 is selectively reacted to produce a second combustion chamber single stage combustion product gas. That is, in the event of such a single stage combustion, the orifice 75 is a controlling orifice. As identified above, in accordance with one preferred embodiment of the invention, the second gas-generating pyrotechnic material 40 has a burn time or duration that is less than about 50 msec and, preferably, a burn time or duration in the range of about 35 to 40 msec during such a single stage combustion.

During a dual stage combustion and such as for the reasons described above, the diffuser orifices 18 now throttle the combustion of at least a portion of the supply of the first gas-generating pyrotechnic material 40, wherein at least a portion of the supply of the first gas-generating pyrotechnic material 40 reacts to produce a first combustion chamber dual stage combustion product gas. During the dual stage combustion, the first gas-generating pyrotechnic material 40 has a relatively high combustion pressure. Preferably, the diffuser orifices 18 serve to control the internal combustion pressure developed within the first combustion chamber 30 so that the internal combustion pressure is at least about 2500 psi, preferably at least about 3500 psi. Further, the first gas-generating pyrotechnic material 40 has a burn time or duration of less than about 60 msec during the dual stage combustion.

During the dual stage combustion, in addition to throttling the combustion of at least a portion of the supply of the first gas-generating pyrotechnic material 40, the diffuser orifices 18 throttle the combustion of at least a portion of the supply of the second gas-generating pyrotechnic material 70, wherein the supply of the second gas-generating pyrotechnic material 70 reacts to produce a second combustion chamber dual stage combustion product gas. Preferably, during the dual stage combustion an internal combustion pressure developed within the second combustion chamber 60 is greater than about 2500 psi, preferably at least about 3500 psi.

In accordance with one preferred embodiment of the invention, reaction initiation of at least a portion of the second gas-generating pyrotechnic material 70 is offset about 5 msec to about 30 msec, preferably about 10 msec, with respect to the reaction initiation of at least a portion of the supply of the first gas-generating pyrotechnic material 40. For example, in one embodiment of the invention, the supply of the first gas-generating pyrotechnic material 40 may be initiated to react to produce the first combustion chamber dual stage product gas, and after a delay of about 10 msec the supply of second gas-generating pyrotechnic material 70 may be initiated to react to produce the second combustion chamber dual stage product gas.

As described above and in accordance with a preferred embodiment of the invention, with both the first and the second combustion chambers operating, the combined inflation fluid flow is sufficiently great as to overwhelm the diffuser exit area (e.g., the diffuser orifices). As a result, the flow choke point or throttling orifice area is effectively relocated or moved from the exit areas or orifices of each of the combustion chambers, respectively, to the diffuser exit area (e.g., the diffuser orifices) and such that the net operating pressure within the inflator device is controllably increased. Further, as the internal combustion pressure within the inflator device 10, and hence within the first combustion chamber 30 increases, the burn rate of the supply of the first gas-generating pyrotechnic material 40 increases due to the increased internal combustion pressure and the first gas-generating pyrotechnic material high burn rate pressure exponent.

Method of Operation

During operation of the inflator device 10, at least one of the first initiator 50 and the second initiator 80 receives a signal from the control assembly 90 in operational control communication with the inflator device 10. The control assembly 90 provides a reaction initiating signal to one of the first initiator 50 to initiate reaction of at least a portion of the supply of the first gas-generating pyrotechnic material 40 contained within the first combustion chamber 30 and the second initiator 80 to initiate reaction of at least a portion of the supply of the second gas-generating pyrotechnic material 70 contained within the second combustion chamber 60 during the single stage combustion. Alternatively, during a dual stage combustion, the control assembly provides a reaction initiating signal to the first initiator 50 to initiate reaction of at least a portion of the supply of the first gas-generating pyrotechnic material 40 and to the second initiator 80 to initiate reaction of at least a portion of the supply of the second gas-generating pyrotechnic material 70.

For example, if an occurrence is detected that requires a relatively slow deployment of the connected airbag or restraint system, the control assembly 90 provides the first initiator 50 with a reaction initiating signal to initiate the reaction of the supply of the first gas-generating pyrotechnic material 40 to produce the first combustion chamber single stage combustion product gas. Alternatively, the second initiator 80 may receive a signal from the control assembly 90 to selectively initiate the reaction of the supply of second gas-generating pyrotechnic material 70 to produce the second combustion chamber single stage combustion product gas.

During a dual stage combustion wherein a relatively quicker deployment of the connected airbag or restraint system is required, the first initiator 50 receives a reaction initiating signal which activates the first initiator 50 to initiate the combustion of the supply of the first gas-generating pyrotechnic material 40. Simultaneously, or preferably after a time delay of about 10 msec, the second initiator 80 also receives a signal which activates the second initiator 80 to initiate the combustion of the supply of the second gas-generating pyrotechnic material 70 to produce the second combustion chamber dual stage combustion product gas. The combustion of the supply of the second gas-generating pyrotechnic material 70 results in an increase in the internal combustion pressure within the inflator device 10, thereby increasing the internal combustion pressure within the first combustion chamber 30, as well as within the second combustion chamber 60. The internal combustion pressure within the first combustion chamber 30 increases as a result of the additional mass flow due to the combustion of the supply of the second gas-generating pyrotechnic material 70, and the pressure dependent burn rate of the first gas-generating pyrotechnic material 40 correspondingly increases to produce a first combustion chamber dual stage combustion product gas.

As described above, during a single stage combustion, the combustion of either the first gas-generating pyrotechnic material 40 or the second gas-generating pyrotechnic material 70 does not by itself provide a sufficient mass flow for the product gas mass flow to be throttled by the diffuser orifices 18. Thus, the orifices 45, 75 formed by the respective combustion chambers 30, 60 throttle the product gas mass flow. Conversely, during a dual stage combustion, combustion of each of the first gas-generating pyrotechnic material 40 and the second gas-generating pyrotechnic material 70 provides sufficient product gas mass flow to be throttled by the diffuser orifices 18.

The present invention is described in further detail in connection with the following examples which illustrates or simulates various aspects involved in the practice of the invention. It is to be understood that all changes that come within the spirit of the invention are desired to be protected and thus the invention is not to be construed as limited by these examples.

### EXAMPLES

In these tests, an inflator device in accordance with one preferred embodiment of the invention, as shown in FIG. 1, was used. The test inflator included:
1) as the supply of the first gas-generating pyrotechnic material a propellant in accordance with the above-identified Taylor et al., U.S. Pat. No. 6,103,030, issued 15 Aug. 2000, and which pyrotechnic material had a burn rate (r_{b}) of 0.45 inch per second at a pressure of 1000 and a pressure exponent (n) of 0.65; and
2) as the supply of the second gas-generating pyrotechnic material a propellant in accordance with Mendenhall et al., U.S. 2003/0106624, published 12 Jun. 2003, and which pyrotechnic material (included: approximately 54 weight percent basic copper nitrate, approximately 25 weight percent guanidine nitrate, approximately 20 weight percent copper complex of diammonium bitetrazole, and approximately 1-2 weight percent aluminum oxide) had a burn rate (r_{b}) of 1.06 inch per second at a pressure of 1000 and a pressure exponent (n) of 0.32.

During the single stage combustion, the supply of the first gas-generating pyrotechnic material combusted at a relatively low combustion pressure of about 1,200 psi and thereby achieved a burn time or duration of about 80 msec. The product gas mass flow was throttled by the orifice formed by the first combustion chamber, as such product gas mass flow was of insufficient magnitude to be throttled by the diffuser orifices.

During the dual stage combustion, the added product gas mass flow from the second combustion chamber resulted in the combustion process being throttled by diffuser orifices, and increased the internal combustion pressure developed within the first combustion chamber, as well as the second combustion chamber. At the increased internal combustion pressure, the supply of first gas-generating pyrotechnic material burned for a duration of about 55 msec to about 60 msec.

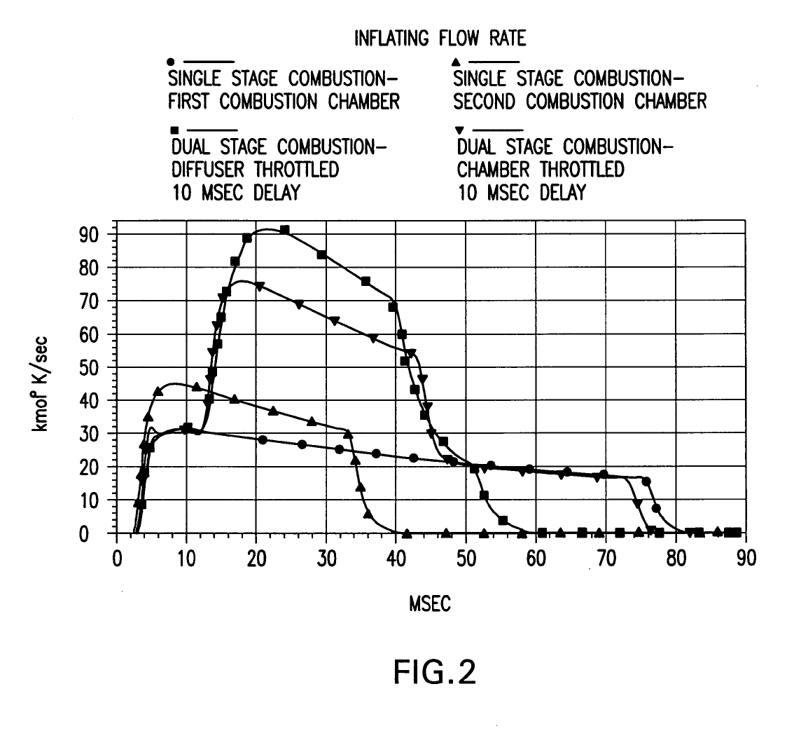

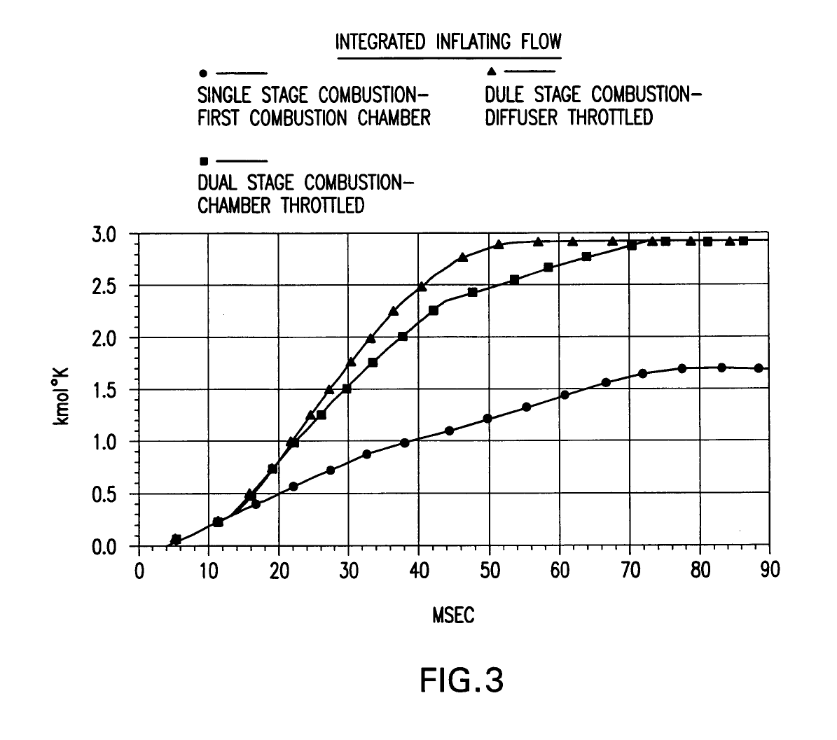

An inflating flow rate and an integrated inflating flow were measured for each of the following combustion processes: a single stage combustion wherein the first gas-generating pyrotechnic material was reacted to produce the first combustion chamber single stage combustion product gas; a single stage combustion wherein the second gas-generating pyrotechnic material was reacted to produce the second combustion chamber single stage combustion product gas; a dual stage combustion wherein the first gas-generating pyrotechnic material was reacted to produce the first combustion chamber dual stage combustion product gas, the second gas-generating pyrotechnic material was reacted to produce the second combustion chamber dual stage combustion product gas and the diffuser orifices throttled the dual stage combustion; and a dual stage combustion wherein the first gas-generating pyrotechnic material was reacted to produce the first combustion chamber dual stage combustion product gas, the second gas-generating pyrotechnic material was reacted to produce the second combustion chamber dual stage combustion product gas and the chamber orifices 45 and 75 independently throttled or controlled the dual stage combustion. During the dual stage combustion processes, the supply of first gas-generating pyrotechnic material was initiated to react to produce the first combustion chamber dual stage product gas. After a 10 msec delay, the supply of second gas-generating pyrotechnic material was initiated to react to produce the second combustion chamber dual stage combustion product gas. FIGS. 2 and 3 show the inflating flow rate and the integrated inflating flow, respectively, for each of the configurations and combustion processes described above.

Referring to FIGS. 2 and 3, the results indicate that the burn duration of the first gas-generating pyrotechnic material can be altered, between the single stage combustion and the dual stage combustion, by at least about 20 msec. For example, as shown in FIG. 2, during the single stage combustion the supply of the first gas-generating pyrotechnic material had a burn time or duration of at least about 80 msec and during the dual stage combustion the supply of the first gas-generating pyrotechnic material had a burn time or duration of less than about 60 msec.

As shown in FIG. 2, the first gas-generating pyrotechnic material of the example had a single stage peak or maximum inflating flow rate of at least about 30 kmol-K/sec with a burn time or duration of about 80 msec. Additionally, the first gas-generating pyrotechnic material has a maximum integrated inflating flow of about 1.7 kmol-K during the single stage combustion, as shown in FIG. 3. During the single stage combustion, the second gas-generating pyrotechnic material had a maximum inflating flow rate of at least about 44 kmol-K/sec and a burn time or duration not greater than about 40 msec.

However, during the dual stage combustion, the first gas-generating pyrotechnic material had a burn time or duration not greater than about 60 msec, while the second gas-generating pyrotechnic material had a burn time or duration not greater than about 40 msec. Further, during the dual stage combustion, the first gas-generating pyrotechnic material and the second gas-generating pyrotechnic material had a combined maximum inflating flow rate of at least about 90 kmol-K/sec, as shown in FIG. 2, and a combined maximum integrated inflating flow of about 2.9 kmol-K, as shown in FIG. 3.

Thus, the inflator device of the invention provides a long burning, low mass flow rate single stage combustion, where one of the first gas-generating pyrotechnic material and the second gas-generating pyrotechnic material is initiated to react to produce a single stage combustion product gas suitable in response to a low speed collision and out-of-position occupant concerns, and a short burning, high mass flow rate dual stage combustion, where each of the first gas-generating pyrotechnic material and the second gas-generating pyrotechnic material is initiated to react to produce a high mass flow rate dual stage product gas suitable in response to a high speed collision.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. An inflator device comprising:
a diffuser chamber;
a first combustion chamber connected to said diffuser chamber;
a supply of a first gas-generating pyrotechnic material having a burn rate that is pressure dependent contained within said first combustion chamber and wherein at least a portion of said supply of the first gas-generating pyrotechnic material is reactable, the first gas-generating pyrotechnic material having a burn rate pressure dependency of at least about 0.55, where the burn rate pressure dependency is represented by n in a burn rate expression:
r_{b}=k(P)ⁿ
where r_{b} is the burn rate of the first gas-generating pyrotechnic material, k is a constant, P is a combustion pressure, and n is a slope of a linear regression line drawn through a log-log plot of burn rate versus pressure;
a controlling orifice formed by said first combustion chamber and providing independent fluidic communication between said first combustion chamber and said diffuser chamber, said controlling orifice throttling a single stage combustion wherein said supply of the first gas-generating pyrotechnic material is selectively reactable to produce a first combustion chamber single stage combustion product gas;
a second combustion chamber connected to said diffuser chamber;
a supply of a second gas-generating pyrotechnic material contained within said second combustion chamber and wherein at least a portion of said supply of the second gas-generating pyrotechnic material is reactable;
a controlling orifice formed by said second combustion chamber and providing independent fluidic communication between said second combustion chamber and said diffuser chamber, said controlling orifice throttling a single stage combustion wherein said supply of the second gas-generating pyrotechnic material is selectively reactable to produce a second combustion chamber single stage combustion product gas; and
a plurality of diffuser orifices formed in said diffuser chamber, said diffuser orifices throttling a dual stage combustion wherein said supply of the first gas-generating pyrotechnic material is reactable to produce a first combustion chamber dual stage combustion product gas and said supply of the second gas-generating pyrotechnic material is reactable to produce a second combustion chamber dual stage combustion product gas.

2. The inflator device of claim 1 wherein during the single stage combustion of said supply of the first gas-generating pyrotechnic material, said supply of the first gas-generating pyrotechnic material having a burn duration of at least about 60 msec.

3. The inflator device of claim 1 wherein during the dual stage combustion of said supply of the first gas-generating pyrotechnic material, said supply of the first gas-generating pyrotechnic material having a burn duration of less than about 60 msec.

4. The inflator device of claim 1 wherein during the single stage combustion and the dual stage combustion of said supply of the second gas-generating pyrotechnic material, said supply of the second gas-generating pyrotechnic material having a burn duration of less than about 50 msec.

5. The inflator device of claim 1 wherein during the dual stage combustion the reaction of said supply of the second gas-generating pyrotechnic material is offset about 5 msec to about 30 msec with respect to the reaction of said supply of the first gas-generating pyrotechnic material.

6. The inflator device of claim 1 further comprising:
a first initiator in discharge communication with said first combustion chamber, and in operational initiating contact with said supply of the first gas-generating pyrotechnic material; and
a second initiator in discharge communication with said second combustion chamber, and in operational initiating contact with said supply of the second gas-generating pyrotechnic material,
wherein during the single stage combustion one of said first initiator and said second initiator is activatable, wherein activation of said first initiator results in initiation of the reaction of said supply of the first gas-generating pyrotechnic material and activation of said second initiator results in initiation of the reaction of said supply of the second gas-generating pyrotechnic material, and during the dual stage combustion said first initiator is activatable to initiate the reaction of said supply of the first gas-generating pyrotechnic material and said second initiator is activatable to initiate the reaction of said supply of the second gas-generating pyrotechnic material.

7. A method for operating the inflator device of claim 6 comprising:
initiating one of said first initiator to initiate reaction of at least a portion of said supply of the first gas-generating pyrotechnic material to produce said first combustion chamber single stage combustion product gas and said second initiator to initiate reaction of at least a portion of said supply of the second gas-generating pyrotechnic material to produce said second combustion chamber single stage combustion product gas.

8. A method for operating the inflator device of claim 6 comprising:
initiating said first initiator to initiate reaction of at least a portion of said supply of the first gas-generating pyrotechnic material to produce said first combustion chamber dual stage combustion product gas; and
initiating said second initiator to initiate reaction of at least a portion of said supply of the second gas-generating pyrotechnic material to produce said second combustion chamber dual stage combustion product gas, wherein an internal combustion pressure developed within said first combustion chamber increases to increase the burn rate of the first gas-generating pyrotechnic material.

9. The inflator device of claim 1 further comprising a cooling medium contained within said diffuser chamber.

10. The inflator device of claim 1 wherein during the single stage combustion the first gas-generating pyrotechnic material has a maximum inflating flow rate of at least about 30 kmol-K/sec.

11. The inflator device of claim 1 wherein during the single stage combustion the first gas-generating pyrotechnic material has a maximum integrated inflating flow of about 1.7 kmol-K.

12. The inflator device of claim 1 wherein during the single stage combustion the second gas-generating pyrotechnic material has a maximum inflating flow rate of at least about 44 kmol-K/sec.

13. The inflator device of claim 1 wherein during the dual stage combustion the first gas-generating pyrotechnic material and the second gas-generating pyrotechnic material have a combined maximum inflating flow rate of at least about 90 kmol-K/sec.

14. The inflator device of claim 1 wherein during the dual stage combustion the first gas-generating pyrotechnic material and the second gas-generating pyrotechnic material have a combined maximum integrated inflating flow of about 2.9 kmol-K.

15. The inflator device of claim 1 wherein during the dual stage combustion an internal pressure of at least about 2500 psi is developed within each of said first combustion chamber and said second combustion chamber.

16. The inflator device of claim 1 wherein the first gas-generating pyrotechnic material having a burn rate pressure dependency of at least about 0.65.

17. The inflator device of claim 1 wherein the first gas-generating pyrotechnic material having a burn rate pressure dependency within a range of about 0.65 to about 0.70.

18. The inflator device of claim 1 wherein said supply of the second gas-generating pyrotechnic material has a burn rate that is pressure dependent, the second gas-generating pyrotechnic material having a burn rate pressure dependency of at least about 0.55, where the burn rate pressure dependency is represented by n in a burn rate expression:
r_{b}=k(P)ⁿ
where r_{b} is the burn rate of the second gas-generating pyrotechnic material, k is a constant, P is a combustion pressure, and n is a slope of a linear regression line drawn through a log-log plot of burn rate versus pressure.

19. An inflator device comprising:
a diffuser chamber;
a first combustion chamber connected to said diffuser chamber;
a supply of a first gas-generating pyrotechnic material having a burn rate that is pressure dependent contained within said first combustion chamber and wherein at least a portion of said supply of the first gas-generating pyrotechnic material is reactable, the first gas-generating pyrotechnic material having a burn rate pressure dependency of at least about 0.55, where the burn rate pressure dependency is represented by n in a burn rate expression:
r_{b}=k(P)ⁿ
where r_{b} is the burn rate of the first gas-generating pyrotechnic material, k is a constant, P is a combustion pressure, and n is a slope of a linear regression line drawn through a log-log plot of burn rate versus pressure;
a first initiator in discharge communication with said first combustion chamber, and in operational initiation communication with said supply of the first gas-generating pyrotechnic material, said first initiator selectively initiating reaction of said supply of the first gas-generating pyrotechnic material in one of a single stage combustion and a dual stage combustion;
at least one controlling orifice formed by said first combustion chamber and providing independent fluidic communication between said first combustion chamber and said diffuser chamber, said at least one controlling orifice throttling the reaction of said supply of the first gas-generating pyrotechnic material during the single stage combustion to produce a first combustion chamber single stage product gas;
a second combustion chamber connected to said diffuser chamber;
a supply of a second gas-generating pyrotechnic material contained within said second combustion chamber and wherein at least a portion of said supply of the second gas-generating pyrotechnic material reactable;
a second initiator in discharge communication with said second combustion chamber, and in operational initiation communication with said supply of the second gas-generating pyrotechnic material, said second initiator selectively initiating reaction of said supply of second gas-generating pyrotechnic material in one of the single stage combustion and the dual stage combustion;
at least one controlling orifice formed by said second combustion chamber, and providing independent fluidic communication between said second combustion chamber and said diffuser chamber, said at least one controlling orifice throttling the reaction of said supply of second gas-generating pyrotechnic material during the single stage combustion to produce the second combustion chamber single stage product gas; and
a plurality of diffuser orifices formed by said diffuser chamber, said diffuser orifices throttling the reaction of said supply of the first gas-generating pyrotechnic material and said supply of the second gas-generating pyrotechnic material during the dual stage combustion, wherein said supply of the first gas-generating pyrotechnic material is reactable to produce a first combustion chamber dual stage combustion product gas and said supply of the second gas-generating pyrotechnic material is reactable to produce a second combustion chamber dual stage combustion product gas.

20. The inflator device of claim 19 wherein said supply of the second gas-generating pyrotechnic material has a burn rate that is pressure dependent, the second gas-generating pyrotechnic material having a burn rate pressure dependency of at least about 0.55, where the burn rate pressure dependency is represented by n in a burn rate expression:
r_{b}=k(P)ⁿ
where r_{b} is the burn rate of the second gas-generating pyrotechnic material, k is a constant, P is a combustion pressure, and n is a slope of a linear regression line drawn through a log-log plot of burn rate versus pressure.

21. The inflator device of claim 20 wherein at least one of the first gas-generating pyrotechnic material and the second gas-generating pyrotechnic material having a burn rate pressure dependency of at least about 0.65.

22. The inflator device of claim 20 wherein at least one of the first gas-generating pyrotechnic material and the second gas-generating pyrotechnic material having a burn rate pressure dependency of about 0.65 to about 0.70.

23. The inflator device of claim 19 wherein during the single stage combustion said at least one controlling orifice formed in said first combustion chamber controls an internal combustion pressure developed within said first combustion chamber.

24. The inflator device of claim 19 wherein during the single stage combustion said at least one controlling orifice formed in said second combustion chamber controls an internal combustion pressure developed within said second combustion chamber.

25. The inflator device of claim 19 wherein during the dual stage combustion said plurality of diffuser orifices control an internal combustion pressure developed within said first combustion chamber and said second combustion chamber.

26. The inflator device of claim 19 wherein during the single stage combustion an internal combustion pressure formed within one of said first combustion chamber and said second combustion chamber is not greater than about 2000 psi.

27. The inflator device of claim 19 wherein during the dual stage combustion an internal combustion pressure developed within said first combustion chamber and said second combustion chamber is greater than about 2500 psi.

28. A combination comprising:
an inflator device including a diffuser chamber forming a plurality of diffuser orifices, a first combustion chamber connected to said diffuser chamber containing a supply of a first gas-generating pyrotechnic material having a burn rate that is pressure dependent, the first gas-generating pyrotechnic material having a burn rate pressure dependency of at least about 0.55, a first initiator in discharge communication with said first combustion chamber, and in operational initiating contact with said supply of the first gas-generating pyrotechnic material, at least one controlling orifice formed by said first combustion chamber providing independent fluidic communication between said first combustion chamber and said diffuser chamber, a second combustion chamber connected to said diffuser chamber containing a supply of a second gas-generating pyrotechnic material, a second initiator in discharge communication with said second combustion chamber, and in operational initiating contact with said supply of the second gas-generating pyrotechnic material, and at least one controlling orifice formed by said second combustion chamber providing independent fluidic communication between said second combustion chamber and said diffuser chamber; and
a control assembly in operational control communication with said inflator device, and providing a reaction initiating signal to one of said first initiator to initiate reaction of at least a portion of said supply of the first gas-generating pyrotechnic material contained within said first combustion chamber and said second initiator to initiate reaction of at least a portion of said supply of the second gas-generating pyrotechnic material contained within said second combustion chamber during a single stage combustion, and providing a reaction initiating signal to said first initiator to initiate reaction of said supply of the first gas-generating pyrotechnic material and said second initiator to initiate reaction of said supply of the second gas-generating pyrotechnic material during a dual stage combustion.
